(19) United States
(12) Patent Application Publication
(10) Pub. No.: US 2007/0059519 A1
(43) Pub. Date: Mar. 15, 2007

(54) Barrier coating composition containing an inorganic flake material as well as a device containing this barrier coating composition

(75) Inventors: Iain McCulloch, Southampton (GB); Udo Heider, Winchester (GB); David Sparrowe, Dorset (GB); Robert Hammond-Smith, Dammerham (GB)

Correspondence Address: MILLEN, WHITE, ZELANO & BRANIGAN, P.C., 2200 CLARENDON BLVD., SUITE 1400, ARLINGTON, VA, 22201, US

(73) Assignee: MERCK PATENT GMBH, Darmstadt (DE)

(21) Appl. No.: 10/574,782

(22) PCT Filed: Sep. 16, 2004
(86) PCT No.: PCT/EP04/10395

§ 371 Date: Apr. 6, 2006

(30) Foreign Application Priority Data
Oct. 11, 2003 (EP) 03023009.8

(51) Int. Cl. B32B 5/16; C08K 3/40

(52) U.S. Cl. 428/331; 524/494

(57) ABSTRACT

The present invention relates to a barrier coating composition which is characterized in that it comprises a polymeric material and at least one inorganic flake material, its use as well as to a device, preferably a display, comprising a barrier coating layer, which is characterized in that the barrier coating layer comprises a barrier coating composition of the present invention.

### FIELD OF THE INVENTION

The present invention relates to a barrier coating composition containing an inorganic flake material, which can be used in Organic Field effect transistors, OLED displays, Liquid crystal displays, flexible displays, displays of TV screens, photovoltaic cells, lithium batteries and other similar devices requiring a barrier layer. Furthermore, the present invention relates to a device, preferably a display, containing such a barrier coating composition as well as their fabrication processes. Such a display is particularly suitable for Liquid crystal displays, OLED displays, displays of TV screens and other flexible displays.

### PRIOR ART

Devices, such as Organic Field effect transistors, Liquid crystal displays, OLED displays, flexible displays, photovoltaic cells and lithium batteries, normally contain reactive organic materials. Unfortunately, these reactive materials are susceptible to water and/or oxygen. Therefore, these devices need to have a barrier coating to allow an efficient, long-term operation.

At the present glass sheets or metal casings are primarily used as barrier layers to prevent the egress of water and/or oxygen. Nevertheless, the use of glass and metal causes weight and rigidity problems and requires a lamination step in fabrication.

Instead of glass and metal, more recently laminated sheets comprising alternate layers of polyethyleneterephthalate (PET) and an inorganic material such as silica, alumina or silicon nitride have been used. Such a substrate is e.g. Barix®, sold by Vitex. The disadvantage of these laminated sheets is that they require several stages of vacuum deposition to build up the required structure and require a lamination step in fabrication. For display applications solution based processes are more suitable.

Problems to be Solved

Therefore, it was an aim of the present invention to develop a coating composition which exhibits:
the required barrier properties,
the required clarity,
the required flexibility and
a low weight,
   and which can be used with Organic Field effect transistors, Liquid crystal displays, OLED displays, flexible displays, displays of TV screens, photovoltaic cells, lithium batteries and other similar devices requiring a barrier layer.

A further aim of the present invention was to develop a coating composition which should be preferably solution processable, more preferably solution processable in a single step continuous process.

The Present Invention

Surprisingly it has been found that it is possible to increase the barrier properties of polymeric materials by incorporating relatively large (≧1 μm) flakes of an inorganic material into these polymeric materials.

Therefore, according to the present invention there is provided a barrier coating composition which is characterized in that it comprises a polymeric material and at least one inorganic flake material.

As polymeric materials all materials which are polymerizable, preferably UV-polymerizable, and which are known to a person skilled in the art can be used. Preferred polymeric materials are polyethylenes (PE), polypropylenes (PP), polyethyleneterephthalates (PET), polynaphthaleneterephthalates (PEN), polyvinylidene chlorides (PVDC), polyacrylates, polymethacrylates, polyurethanes (PU), polyamides (PA), epoxy resins, mercapto esters, e.g. Norland Optical Adhesive 73, liquid-crystalline polymers (LCP) and ORMOCERs® (i.e. inorganic-organic hybrid polymers from the Fraunhofer-Gesellschaft).

It is also possible to use mixtures of two or more different polymeric materials.

The polymeric material is preferably present in the barrier coating composition in an amount of 50 to 99% by weight, more preferably in an amount of 60 to 97% by weight and most preferably in an amount of 70 to 95% by weight.

As inorganic flake material all materials which are known to a person skilled in the art and which are suitable for the purpose of the present application can be used. Preferred inorganic flake materials include mica, alumina, silica and glass. More preferably silica and glass are used as inorganic flake material. The most preferred inorganic flake material is glass.

The thickness of the inorganic flake material is preferably less than 1.0 μm, more preferably less than 0.5 μm and most preferably less than 0.3 μm.

The average particle size of the inorganic flake material is preferably in the range of 1 to 1000 μm and more preferably in the range of 50 to 500 μm. Preferred inorganic flake particles have an average particle size in the range of 100 to 400 μm and a thickness of 0.1 to 0.5 μm, preferably of 0.1 to 0.3 μm. The aspect ratio of the inorganic flakes is in the range of 20 to 5000, preferably in the range of 200 to 2000.

Optionally the inorganic flake particles can be coated with one or more layers selected from the group consisting of metal oxides, metal suboxides, metal fluorides, metal oxyhalides, metal chalcogenides, metal nitrides, metal carbides or mixtures thereof.

The inorganic flake material is preferably present in the barrier coating composition in an amount of 1 to 50% by weight, more preferably in an amount of 3 to 40% by weight and most preferably in an amount of 5 to 30% by weight.

Beside the polymeric material and the inorganic flake material, the barrier coating composition can contain additives, fillers, surfactants and other auxiliary materials which are known to a person skilled in the art in an amount appropriate to their function.

In a preferred embodiment, the barrier coating composition of the present application is transparent. Transparency is obviously important for display applications, where one has to look through the barrier coating.

The transparency required for photovoltaic devices must not necessarily be as high as for the display applications. If the barrier coating is on the reverse side of the display or in other applications, such as lithium batteries or Organic Field effect transistors, then the transparency is not a consideration.

The barrier coating composition of the present application can be prepared either in that the inorganic flake material is directly mixed with the polymeric material or in that the inorganic flake material is in a first step mixed with the corresponding monomeric material and the monomeric material of the mixture is subsequently polymerised. In a preferred embodiment, the polymeric as well as the monomeric material is used as a solution or dispersion in an organic solvent.

The barrier coating composition of the present application can be used in barrier coating layers of devices such as Organic Field effect transistors, Liquid crystal displays, OLED displays, flexible displays, displays of TV screens, photovoltaic cells, lithium batteries and other similar devices which require a barrier layer.

Furthermore, according to the present invention there is also provided a device, preferably a display, comprising at least one, preferably one barrier coating layer which is characterized in that the at least one barrier coating layer comprises a barrier coating composition of the present application. In a preferred embodiment, the barrier coating layer consists of a barrier coating composition of the present application.

The barrier coating layer preferably has a thickness of 10 to 1000 μm, more preferably of 10 to 300 μm.

Optionally, the barrier coating layer is applied on a substrate. As substrates all materials which are known to a person skilled in the art and which are suitable for the purpose of the present application can be used. Preferred as substrate material is polyethyleneterephthalate.

If the barrier coating layer is used together with the substrate, it can be prepared directly on the substrate. If the barrier coating layer is used alone without a substrate, it is prepared on a carrier substrate and removed after its preparation.

In one embodiment, the barrier coating layer can be prepared in that a solution or dispersion of the barrier coating composition is brought onto a substrate and finally the organic solvent is evaporated. Optionally, after the preparation of the barrier layer is finished, it can be removed from the substrate.

In another embodiment, the barrier coating layer can be prepared in that a solution or dispersion of a polymerizable material containing at least one inorganic flake material is brought onto the substrate, the polymerizable material is then polymerised, preferably via UV irradiation, and finally the organic solvent is evaporated. Optionally, after the preparation of the barrier layer is finished, it can be removed from the substrate.

Therefore, according to the present application there is also provided a barrier coating formulation, comprising:
a) a polymeric material and/or a polymerizable material,
b) at least one inorganic flake material and
c) at least one organic solvent.

Beside the materials mentioned above, the barrier coating formulation can contain additives, fillers, surfactants and other auxiliary materials which are known to a person skilled in the art in an amount appropriate to their function.

The barrier coating formulation can be processed by any printing or wet coating technology which is known to a person skilled in the art and which is suitable to produce the barrier coating composition or barrier coating layer of the present invention.

If the barrier coating formulation is applied in a multi step process, it is possible either to vary the thickness of the barrier coating layer or to produce a multi layer barrier coating, especially if the composition changes from step to step.

### PREFERRED EMBODIMENT OF THE PRESENT INVENTION

In a preferred embodiment of the present invention there is provided a barrier coating composition which is characterized in that it comprises a polymeric material and glass flakes.

As glass flakes all materials which are known to a person skilled in the art and which are suitable for the purpose of the present application can be used. Preferred types of glass are: window glass, A-glass, C-glass, E-glass, ECR-glass, Duran®-glass, laboratory apparatus glass, optical glass and quartz-glass. More preferred is E-glass, ECR-glass and quartz-glass. The refractive index of the glass flakes is preferably in the range of 1.3 to 2.9, more preferably in the range of 1.35 to 2.3, and most preferably in the range of 1.4 to 1.8. In a further preferred embodiment, the refractive index of the glass is selected to match the refractive index of the polymer matrix so as to minimise the dispersion of light.

The thickness of the glass flakes is preferably less than 1.0 μm, more preferably less than 0.5 μm and most preferably less than 0.3 μm.

The average particle size of the glass flakes is preferably in the range of 1 to 1000 μm and more preferably in the range of 50 to 500 μm. Preferred glass flakes have an average particle size in the range of 100 to 400 μm and a thickness of 0.1 to 0.5 μm, preferably of 0.1 to 0.3 μm. The aspect ratio of the glass flakes is in the range of 20 to 5000, preferably in the range of 200 to 2000.

Glass flakes having the dimensions described above can be prepared in accordance with the method and apparatus disclosed in EP 0 289 240 A1.

An advantage of the glass flakes is that it is not necessary to exfoliate this material as it is necessary for most of the other inorganic flake materials, like for example in the case of mica.

Optionally the glass particles can be coated with one or more layers selected from the group consisting of metal oxides, metal suboxides, metal fluorides, metal oxyhalides, metal chalcogenides, metal nitrides, metal carbides or mixtures thereof.

The glass flakes are present in the barrier coating composition in an amount of 1 to 50% by weight, preferably in an amount of 3 to 40% by weight and more preferably in an amount of 5 to 30% by weight.

Beside the polymeric material and the glass flakes, the barrier coating composition can contain additives, fillers, surfactants and other auxiliary materials which are known to a person skilled in the art in an amount appropriate to their function.

Therefore, according to the present application there is also provided a barrier coating formulation, comprising:
a) a polymeric material and/or a polymerizable material,
b) glass flakes and
c) at least one organic solvent.

Beside the materials mentioned above, the barrier coating formulation can contain additives, fillers, surfactants and other auxiliary materials which are known to a person skilled in the art in an amount appropriate to their function.

The present invention is in the following explained in detail with working examples.

### EXAMPLE 1

### Preparation of Calcium Coated Glass Slides

Glass slides (25×25×1 mm) were prepared by ultrasonic washing in distilled water, acetone and isopropanol. The prepared slides were then transferred to a Braun glove box (H₂O<0.1 ppm, O₂<0.1 ppm). The slides were placed in a vacuum coating chamber, which is a separate item from the Braun glove box but is situated in the glove box, and covered with a template. This template allowed the deposition of a 1×1 cm square in the middle of each slide. Deposition of calcium was conducted until a layer of 60 nm has been applied. A slide prepared in such a way was left in the glove box and showed no effect after 17 hours.

In a normal atmosphere such an uncoated sample reacted fully in 5 minutes.

### COMPARATIVE EXAMPLE 1

The calcium coated slides were then coated with a sample of Norland Optical Adhesive 73 in the following manner. Ca. 1 g of this adhesive was applied to the centre of the slide. A silicone treated PET release layer was applied to the coating, a glass microscope slide placed on this and a 600 g weight applied to the glass slide. The mixture was left for 30 seconds. The weight was removed and the slide was exposed to UV irradiation (EFOS lamp, 200 mW cm⁻²) for 30 seconds. The glass slide and release layer were removed and then further curing was performed for another 30 seconds. This process gave a film thickness of 28 μm.

In a normal atmosphere such a coated sample slide reacted fully in 29 minutes.

### EXAMPLE 2

In the same way as in comparative example 1, calcium coated slides were coated with a composition of Norland Optical Adhesive 73 containing 5% by weight of glass flakes (20−200 μm×500 nm).

The applied coating was 35 μm thick and in a normal atmosphere a sample coated in such a way reacted fully in 50 minutes.

By dividing the reaction time by thickness the improvement with respect to the coating of comparative example 1 was greater than 40%.

1. A barrier coating composition characterized in that it comprises a polymeric material and at least one inorganic flake material.

2. A barrier coating composition as claimed in claim 1, characterized in that the polymeric material is present in an amount of 50 to 99% by weight.

3. A barrier coating composition as claimed in claim 1, characterized in that the inorganic flake material is present in an amount of 1 to 50% by weight.

4. A barrier coating composition as claimed in claim 1, characterized in that the particle thickness of the inorganic flake material is preferably less than 1.0 μm.

5. A barrier coating composition as claimed in claim 1, characterized in that the average particle size of the inorganic flake material is in the range of 1 to 1000 μm.

6. A barrier coating composition as claimed in claim 1, characterized in that the inorganic flake material are glass flakes.

7. The use of a barrier coating composition as claimed in claim 1 in a barrier coating layer of Organic Field effect transistors, Liquid crystal displays, OLED displays, flexible displays, displays of TV screens, photovoltaic cells and lithium batteries.

8. A device comprising at least one barrier coating layer, characterized in that the at least one barrier coating layer comprises a barrier coating composition as claimed in claim 1.

9. A display comprising at least one barrier coating layer, characterized in that the at least one barrier coating layer comprises a barrier coating composition as claimed in claim 1.

10. A barrier coating formulation comprising
a) a polymeric material and/or a polymerizable material,
b) at least one inorganic flake material and
c) at least one organic solvent.
